(19) United States
(12) Patent Application Publication
(10) Pub. No.: US 2006/0235585 A1
(43) Pub. Date: Oct. 19, 2006

(54) Self-guided cleaning robot

(75) Inventor: Hiroto Tanaka, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/405,138

(22) Filed: Apr. 17, 2006

(30) Foreign Application Priority Data
Apr. 18, 2005 (JP) 2005-119223

(51) Int. Cl. G05D 1/00

(52) U.S. Cl. 701/23

(57) ABSTRACT

First, a self-guided cleaning robot performs map cleaning in which the self-guided cleaning robot refers to cleaning region information (map) and travels. Then, upon performing the map cleaning, it is determined whether or not a traveling state based on results of detection by rotary encoders and a gyro sensor falls within predetermined a permissible range. If it is determined that the traveling state deviates from the permissible range, the map cleaning is finished, and is switched to random cleaning.

### BACKGROUND OF THE INVENTION

1. Field of the Invention

The present invention relates to a self-guided cleaning robot. In particular, the present invention relates to a self-guided cleaning robot capable of performing map cleaning.

2. Description of the Background Art

Conventionally, there is a self-guided cleaning robot. Japanese Laid-Open Patent Publication No. 2003-061882 discloses, as a traveling method (movement trail) of a robot main body, a method for allowing the main body to repeat a straight-ahead movement and a turn movement in a cleaning region so as to gradually fill the region with an almost width of a cleaning nozzle, and a method for allowing the main body to repeat a straight-ahead movement and a random angle turn movement so as to move the main body, and adopts any one of the methods. This publication also discloses that the main body detects an obstacle during cleaning and performs a cleaning operation while navigating around the obstacle.

As described above, the self-guided cleaning robot can detect presence/absence of an obstacle and a distance to the obstacle with the use of an ultrasonic sensor or the like provided in the main body, and can allow the robot main body to travel while navigating around the obstacle.

However, if a person or an object approaches the robot main body, even when the robot main body detects the approaching person or object as an obstacle, the robot main body cannot navigate around the obstacle to thereby collide with the obstacle in some cases.

In order to solve such a problem, Japanese Laid-Open Patent Publication No. 2000-235416 discloses a technique that when the level of load torque applied to a driving motor exceeds a prescribed limit, the driving motor is halted. This technique enables to prevent a driving motor from being burned, a driving wheel from being broken and an obstacle from being damaged, in the case where a robot main body hits the obstacle or fails to travel.

In order to efficiently perform cleaning, it is desirable to allow the robot main body to move so as to gradually fill the cleaning region by repetition of the straight-ahead movement and the turn movement, as disclosed in Japanese Laid-Open Patent Publication No. 2003-061882.

However, this traveling method is effected based on the premise that the robot recognizes its position and direction. Therefore, if the main body collides with an obstacle to thereby lose its position and direction, there is a possibility of generation of a region where cleaning is performed twice or a region where no cleaning is performed. This publication discloses no operation performed when the main body collides with an obstacle in such a manner.

Also, Japanese Laid-Open Patent Publication No. 2000-235416 only discloses an operation of the robot in the case where the robot cannot travel due to collision with an obstacle, and discloses no operation of the robot in the case where the robot can travel even upon collision with an obstacle.

### SUMMARY OF THE INVENTION

The present invention has been made to solve the aforementioned problems, and aims to provide a self-guided cleaning robot capable of reducing an uncleaned region, even in the case of collision with an obstacle.

A self-guided cleaning robot according to an aspect of the present invention includes a suction unit, a time measurement unit, a storage unit, a travel unit, a traveling drive unit, a distance detection unit, an angle detection unit, a first traveling control unit, a mapping unit, a second traveling control unit, a first determination unit, a second determination unit and a switch unit. The suction unit performs a sucking operation for cleaning. The time measurement unit measures a time. The storage unit stores cleaning region information. The travel unit allows a main body to move. The traveling drive unit drives the travel unit to allow the main body to travel. The distance detection unit is a device for detecting a traveling distance of the main body. The angle detection unit is a device for detecting an angle indicative of a moving direction of the main body. The first traveling control unit refers to the cleaning region information to control the traveling drive unit. The mapping unit maps a cleaned partial region on the basis of information from the distance detection unit and the angle distance unit, while map traveling is performed by the first traveling control unit. The second traveling control unit controls the traveling drive unit at random. The first determination unit determines whether or not a traveling distance per unit of a predetermined time is less than a first predetermined value, on the basis of a result of detection by the distance detection unit, while the map traveling is performed. The second determination unit determines whether or not an angular velocity exceeds a second predetermined value, on the basis of a result of detection by the angle detection unit, while the map traveling is performed. The switch unit switches the map traveling to random traveling by the second traveling control unit, in the case where the first determination unit determines that the traveling distance per unit of the predetermined time is less than the first predetermined value and the second determination unit determines that the angular velocity exceeds the second predetermined value.

A self-guided cleaning robot according to another aspect of the present invention includes a suction unit, a storage unit, a travel unit, a traveling control unit, a first traveling control unit, a second traveling control unit, a traveling state determination unit and a switch unit. The suction unit performs a sucking operation for cleaning. The storage unit stores cleaning region information. The travel unit allows a main body to move. The traveling drive unit drives the travel unit to allow the main body to travel. The detection unit detects a traveling state of the main body. The first traveling control unit refers to the cleaning region information to control the traveling drive unit. The second traveling control unit controls the traveling drive unit at random. The traveling state determination unit determines whether or not the traveling state based on a result of detection by the detection unit falls within a preset permissible range, while map traveling is performed by the first traveling control unit. The switch unit switches the map traveling to random traveling by the second traveling control unit, in the case where the traveling state determination unit determines that the traveling state deviates from the permissible range.

Preferably, the detection unit includes a distance detection unit for detecting a traveling distance of the main body, the traveling state includes a traveling distance per unit of a predetermined time based on a result of detection by the distance detection unit, the traveling state determination unit determines whether or not the traveling distance per unit of the predetermined time is less than a predetermined value, and the switch unit switches the map traveling to the random traveling, in the case where the traveling state determination unit determines that the traveling distance per unit of the predetermined time is less than the predetermined value.

Preferably, the detection unit includes an angle detection unit for detecting an angle indicative of a moving direction of the main body, the traveling state includes an angular velocity based on a result of detection by the angle detection unit, the traveling state determination unit determines whether or not the angular velocity exceeds a predetermined value, and the switch unit switches the map traveling to the random traveling, in the case where the traveling state determination unit determines that the angular velocity exceeds the predetermined value.

Preferably, the detection unit includes a distance detection unit for detecting a traveling distance of the main body, and an angle detection unit for detecting an angle indicative of a moving direction of the main body, the traveling state includes a traveling distance per unit of a predetermined time based on a result of detection by the distance detection unit, and an angular velocity based on a result of detection by the angle detection unit, and the traveling state determination unit includes a first determination unit for determining whether or not the traveling distance per unit of the predetermined time is less than a first predetermined value, and a second determination unit for determining whether or not the angular velocity exceeds a second predetermined value.

Preferably, the switch unit switches the map traveling to the random traveling in the case where the first determination unit determines that the traveling distance per unit of the predetermined time is less than the first predetermined value or the second determination unit determines that the angular velocity exceeds the second predetermined value.

Preferably, the switch unit switches the map traveling to the random traveling in the case where the first determination unit determines that the traveling distance per unit of the predetermined time is less than the first predetermined value and the second determination unit determines that the angular velocity exceeds the second predetermined value.

Preferably, the self-guided cleaning robot further includes a mapping unit for mapping a cleaned partial region on the basis of a result of detection by the detection unit, while the map traveling is performed.

Preferably, the self-guided cleaning robot further includes a time measurement unit for measuring a time, and a time determination unit for determining whether or not an elapsed time since the switch unit switches the map traveling to the random traveling exceeds a preset time, the second traveling control unit terminates the random traveling, in the case where the time determination unit determines that the elapsed time exceeds the preset time.

Preferably, the self-guided cleaning robot further includes a time measurement unit for measuring a time, a calculation unit for referring to the cleaning region information stored in the storage unit to calculate a traveling time of the random traveling, in the case where the traveling state determination unit determines that the traveling state deviates from the permissible range, and a time determination unit for determining whether or not an elapsed time since the switch unit switches the map traveling to the random traveling exceeds the calculated traveling time, and the second traveling control unit terminates the random traveling, in the case where the time determination unit determines that the elapsed time exceeds the calculated traveling time.

Preferably, the self-guided cleaning robot further includes a correspondence table in which ratios of an uncleaned region are respectively corresponded to predetermined times, and the calculation unit calculates a ratio of the uncleaned region on the basis of the cleaning region information, and calculates the traveling time on the basis of the calculated ratio and the correspondence table.

Preferably, the self-guided cleaning robot further includes a correspondence table in which areas of an uncleaned region are respectively corresponded to predetermined times, and the calculation unit calculates an area of the uncleaned region on the basis of the cleaning region information, and calculates the traveling time on the basis of the calculated area and the correspondence table.

According to the present invention, if it is determined that a traveling state deviates from a permissible range, a traveling operation while referring to cleaning region information (map) can be switched to random traveling. Accordingly, the traveling operation while referring to the cleaning region information is effected as long as the traveling state falls within the permissible range; therefore, it is possible to perform efficient cleaning. Even when the traveling state deviates from the permissible range, the traveling operation is changed to random traveling; thus, it is possible to reduce an uncleaned region.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an outer appearance perspective view of a cleaner according to an embodiment of the present invention and a modification thereof;

FIG. 2 is a unital view taken along line II-II of FIG. 1;

FIG. 3 shows a block configuration of the cleaner according to the embodiment of the present invention and the modification thereof;

FIG. 4 is a functional block diagram of a CPU in the cleaner according to the embodiment of the present invention;

FIG. 5 is a flowchart showing a flow of cleaning processes executed by the CPU in the embodiment of the present invention;

FIG. 6 is a functional block diagram of a CPU in the cleaner according to the modification of the embodiment of the present invention;

FIGS. 7 and 8 are flowcharts each showing a flow of cleaning processes executed by the CPU in the modification of the embodiment of the present invention.

### DESCRIPTION OF THE PREFERRED EMBODIMENTS

Description will be given of an embodiment of the present invention in detail with reference to the drawings. In the drawings, like reference characters refer to like or corresponding elements and description thereof will not be repeated.

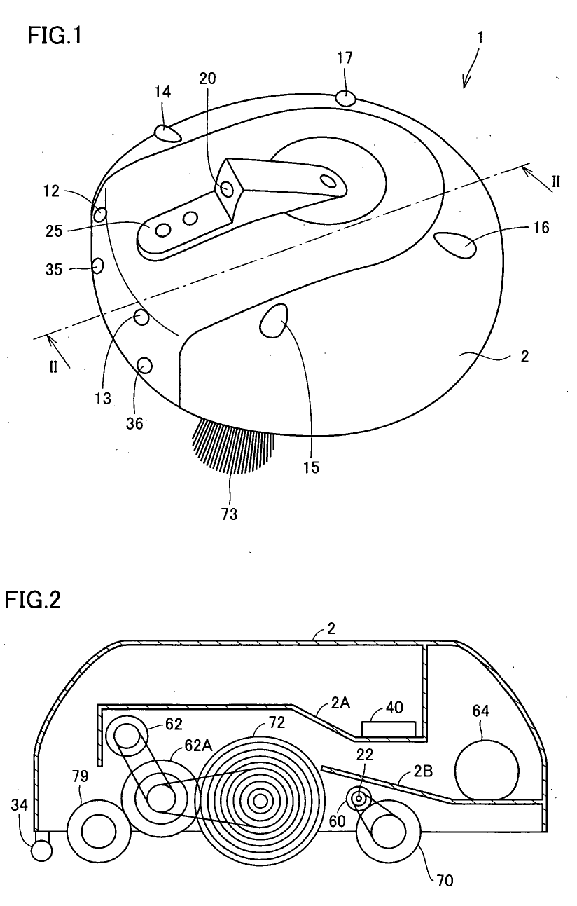

FIG. 1 is an outer appearance perspective view of a self-guided cleaning robot (hereinafter, referred to as “cleaner”) 1 according to the embodiment of present invention.

With reference to FIG. 1, cleaner 1, whose exterior part is covered with an outer jacket 2 and has an almost disc shape. A camera 20, an input unit 25 and proximity sensors 12 to 17 are provided on outer jacket 2. Camera 20 is provided on an almost center of an top face of outer jacket 2 so as to face obliquely upward in a traveling direction. Input unit 25 is configured by switches and the like, and is used when a user inputs information to cleaner 1. Each of proximity sensors 12 to 17 takes a form of, for example, an infrared sensor to sense presence/absence of an obstacle and a distance to the obstacle.

In addition, LEDs (Light Emitting Diodes) 35 and 36 for compensating an illumination upon image capturing by camera 20 are provided below proximity sensors 12 and 13 provided on a front face of outer jacket 2, respectively. Further, a plurality of LEDs (not shown) are also provided below LEDs 35 and 36. Thus, it is possible to detect presence/absence of a floor face.

A bumper (not shown) is provided on a lower portion of the front face of outer jacket 2 in order to further ensure security. Thus, for example, if the user puts his/her hand in a lower portion of the main body during traveling, it is possible to stop the main body.

Cleaner 1 includes side brushes 73 provided below both sides of outer jacket 2 in front thereof. Side brushes 73 enable to collect dust inwardly.

It is to be noted that FIG. 1 shows proximity sensors 12 to 17 as a sensor for sensing presence/absence of an obstacle and a distance to the obstacle; however, a plurality of any other sensors may be provided in addition to proximity sensors 12 to 17.

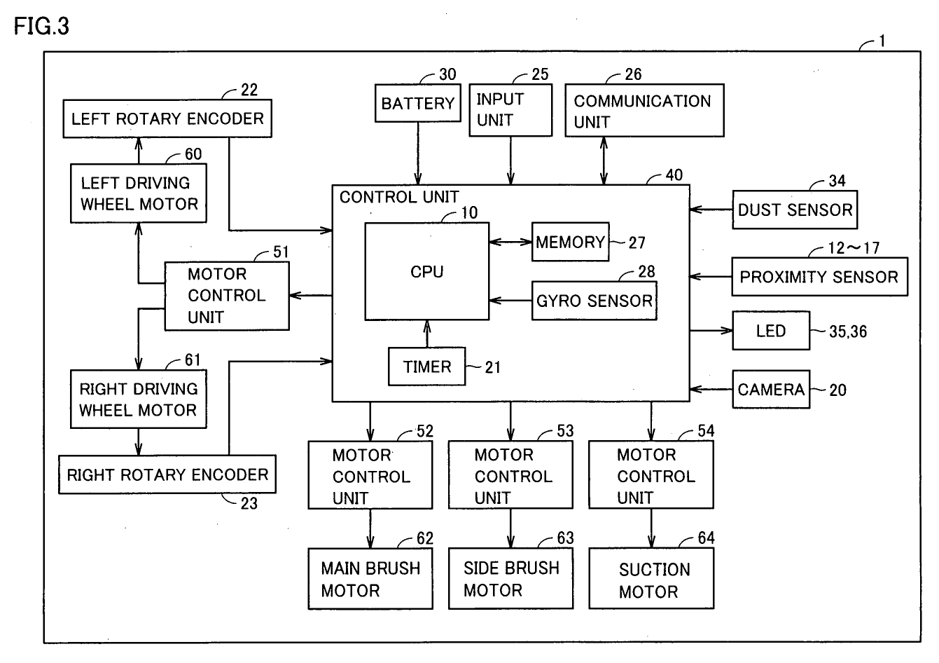

FIG. 2 is a unital view of cleaner 1 taken along line II-II of FIG. 1.

With reference to FIG. 2, support plates 2A and 2B are provided inside outer jacket 2. On support plate 2A, there is provided a control unit 40 into which components for controlling operations of cleaner 1 are incorporated. On an almost center portion of cleaner 1, there is provided a main brush 72 for sweeping dust on a floor face while rotating. When a main brush motor 62 is driven, a driving force from main brush motor 62 is transmitted to main brush 72 through a gear 62A; thus, main brush 72 rotates. The dust swept by main brush 72 is collected in a dust collection cup (not shown). When a suction motor 64 is driven, the swept dust passes through a nozzle (not shown) and, then, is introduced into the dust collection cup. Suction motor 64 is provided on support plate 2B.

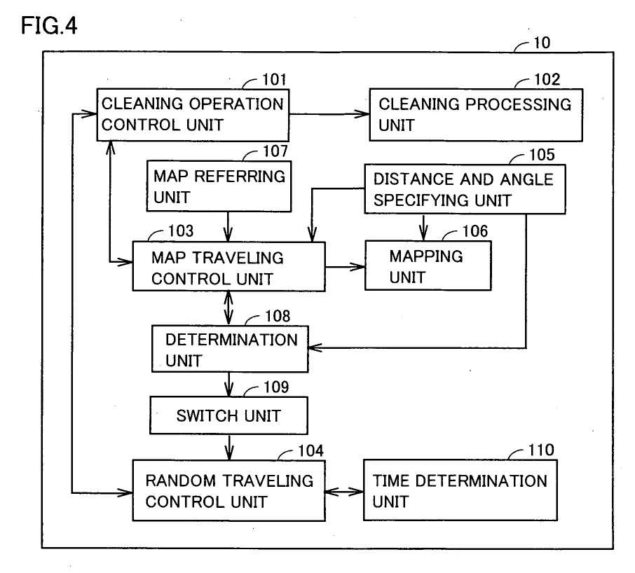

FIG. 2 shows a left driving wheel 70. Cleaner 1 includes left driving wheel 70 and a right driving wheel (not shown) respectively provided on both sides thereof These two driving wheels are driven, so that cleaner 1 travels. When a left driving wheel motor 60 is driven, left driving wheel 70 rotates. Left driving wheel motor 60 is provided with a left rotary encoder 22 for detecting a traveling distance. It is to be noted that a right driving wheel motor 61 (see FIG. 3) is also provided with a right rotary encoder 23 (see FIG. 3) for detecting a traveling distance. As described above, cleaner 1 is provided with rotary encoders capable of detecting a traveling distance, that is, a moving amount, independently of the right and left driving wheel motors.

Cleaner 1 further includes auxiliary wheels respectively provided rearward the left and right driving wheels. An auxiliary wheel 79 is provided rearward left driving wheel 70. Cleaner 1 includes a dust sensor 34 provided at a rear end portion thereof. Dust sensor 34 is a unit including an infrared sensor, and senses an amount of dust on a floor face.

FIG. 3 shows a block configuration of cleaner 1.

As described above, cleaner 1 includes proximity sensors 12 to 17, camera 20, left rotary encoder 22, right rotary encoder 23, input unit 25, LEDs 35, 36, left driving wheel motor 60, right driving wheel motor 61, main brush motor 62, and suction motor 64. In addition, cleaner 1 includes a CPU (Central Processing Unit) 10 for performing various arithmetic operations and control operations, a timer 21 for measuring a time, a communication unit 26 for communicating with an external device, a memory 27 for storing data and programs, a sensor for detecting an angle at which the main body is directed, i.e., a moving direction, e.g., a gyro sensor 28, a chargeable battery 30, and a side brush motor 63 for driving side brushes 73. Further, cleaner 1 includes a motor control unit 51 for controlling left driving wheel motor 60 and right driving wheel motor 61, a motor control unit 52 for controlling the driving of main brush motor 62, a motor control unit 53 for controlling the driving of side brush motor 63, and a motor control unit 54 for controlling the driving of suction motor 64.

In this embodiment, for example, CPU 10, timer 21, memory 27 and gyro sensor 28 are incorporated into control unit 40 (see FIG. 2).

For example, a wireless LAN card is inserted into communication unit 26. Thus, it is possible to establish wireless communication with an external device.

CPU 10 receives information inputted through input unit 25. In addition, CPU 10 receives detection signals from dust sensor 34, proximity sensors 12 to 17, left rotary encoder 22, right rotary encoder 23 and gyro sensor 28. Further, CPU 10 receives data of an image captured by camera 20. CPU 10 can refer to a time measured by timer 21. CPU 10 can control operations of LED 35. CPU 10 writes and reads data into and from memory 27. CPU 10 is connected to motor control units 51 to 54.

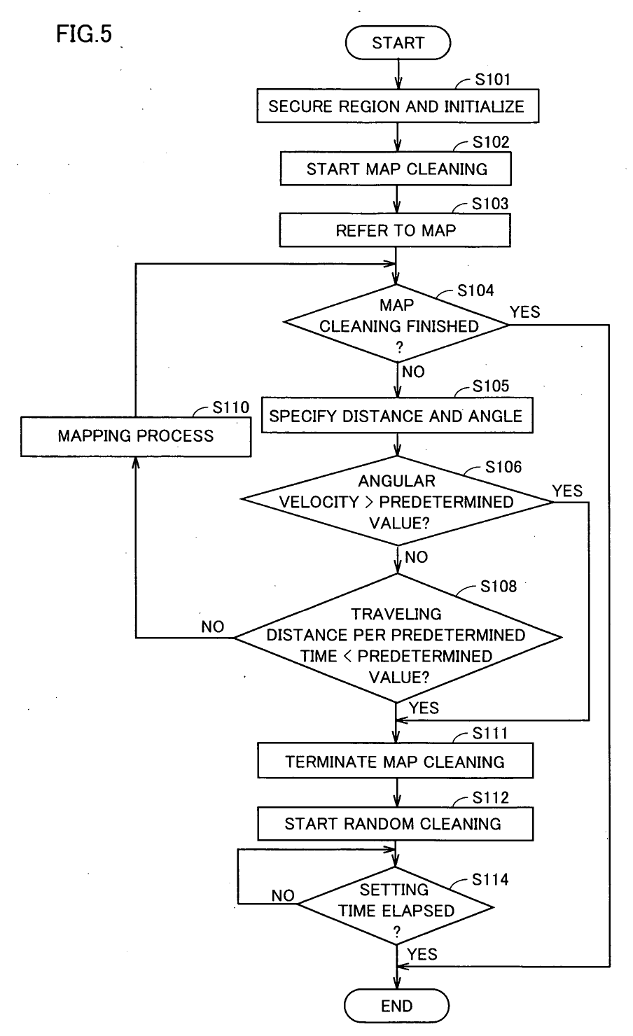

Herein, with reference to FIG. 4, description will be given of functions realized by CPU 10 in the case where cleaner 1 according to the embodiment of the present invention performs a cleaning operation.

With reference to FIG. 4, CPU 10 includes a cleaning operation control unit 101 for controlling a cleaning operation, a cleaning processing unit 102 for receiving a signal from cleaning operation control unit 101 to thereby perform a process concerning the cleaning operation such as suction of dust, a map traveling control unit 103 for performing a traveling operation for map cleaning (hereinafter, referred to as “map traveling”) under the control by cleaning operation control unit 101, and a random traveling control unit 104 for performing a traveling operation for random cleaning (hereinafter, referred to as “random traveling”) under the control by cleaning operation control unit 101.

In this embodiment, “map cleaning” means at least a cleaning operation that cleaner 1 autonomously travels while referring to cleaning region information (hereinafter, referred to as “map”) stored in memory 27, preferably a cleaning operation that cleaner 1 autonomously travels while mapping and referring to the map. In this embodiment, “mapping” is a process also referred to as “map creation”, at least, a process that a cleaned site is marked on a map. In addition, “random cleaning” means a cleaning operation that cleaner 1 autonomously travels on a random route irrespective of the map stored in memory 27.

CPU 10 further includes a distance and angle specifying unit 105 for specifying a traveling distance (moving amount) and an angle (moving direction), a map referring unit 107 for referring to the map stored in memory 27, a mapping unit 106 for mapping a cleaned partial region on the map, a determination unit 108 for determining whether or not cleaner 1 receives a strong impact, and a switch unit 109 for switching map traveling to random traveling.

CPU 10 further includes a time determination unit 110 for determining whether or not a preset time is exceeded in the case where random traveling control unit 104 performs random traveling.

In order to rotate main brush 72 and side brushes 73, cleaning processing unit 102 supplies a driving current to main brush motor 62 and side brush motor 63 through motor control units 52 and 53. Further, in order to suck dust collected by these brushes, cleaning processing unit 102 supplies a driving current to suction motor 64 through motor control unit 54. Cleaning processing unit 102 performs a predetermined process irrespective of map cleaning or random cleaning.

Map traveling control unit 103 controls motor control unit 51 so as to allow cleaner 1 to travel with a predetermined traveling pattern on the basis of the information from map referring unit 107 and the traveling distance and the angle specified by distance and angle specifying unit 105. The predetermined traveling pattern includes, for example, so-called zigzag traveling in which a route is changed little by little while repeating a straight ahead movement and a 180°-turn movement (reciprocating). With this map traveling, it is possible to prevent an uncleaned region from remaining.

For example, random traveling control unit 104 controls motor control unit 51 so as to allow cleaner 1 to travel while repeating a straight ahead movement and a random angle turn movement.

Distance and angle specifying unit 105 specifies a traveling distance on the basis of detection signals from left rotary encoder 22 and right rotary encoder 23. More specifically, distance and angle specifying unit 105 calculates a traveling distance of cleaner 1 from a moving amount of left driving wheel 70 obtained from left rotary encoder 22 and a moving amount of the right driving wheel (not shown) obtained from right rotary encoder 23. Further, distance and angle specifying unit 105 specifies an angle on the basis of a detection signal from gyro sensor 28.

Mapping unit 106 maps a cleaned partial region on the map stored in memory 27, on the basis of the traveling distance and the angle specified by distance and angle specifying unit 105. Upon detection of an obstacle on the basis of signals from proximity sensors 12 to 17, for example, mapping unit 106 fills a site where the obstacle is present with black in the map. Mapping unit 106 also performs a process for creating a matrix-shaped map in a predetermined storage region of memory 27 at the time of start of map cleaning.

Determination unit 108 determines whether or not a traveling state of cleaner 1 falls within a permissible range. Herein, “traveling state” represents amounts of a speed and an angular velocity. More specifically, for example, determination unit 108 determines whether or not a traveling distance per predetermined time is less than a predetermined value on the basis of the traveling distance specified by distance and angle specifying unit 105. Thus, it is possible to determine whether or not the traveling operation of cleaner 1 is halted (locked) or cleaner 1 slides in a lateral direction due to reception of a strong impact. Determination unit 108 determines whether or not an angular velocity is a predetermined value or more, on the basis of the angle specified by distance and angle specifying unit 105. Thus, it is possible to determine whether or not cleaner 1 rotates faster than usual due to reception of a strong impact.

As described above, in this embodiment, the traveling state of cleaner 1 is specified on the basis of detection signals from left rotary encoder 22, right rotary encoder 23 and gyro sensor 28.

If determination unit 108 determines that the traveling state deviates from the permissible range, switch unit 109 switches map traveling to random traveling.

It is to be noted that operations of the respective blocks shown in FIG. 4 may be realized by execution of software stored in memory 27, and at least one of them may be realized by hardware.

Cleaner 1 can execute an operation for security, in addition to the cleaning operation. More specifically, for example, when a time for executing a security operation and information for designating a traveling pattern are inputted through input unit 25, cleaner 1 executes a patrol operation by driving motor control unit 51 so as to travel with the designated traveling pattern, on condition that the time measured by timer 21 becomes the designated time. In the case where cleaner 1 executes such a security operation, if proximity sensors 12 to 17 sense presence or motion of an object or person, which is not assumed ordinarily, camera 20 captures an image of the object or person and, then, the captured image can be transmitted to a predetermined terminal placed away from cleaner 1 through communication unit 26.

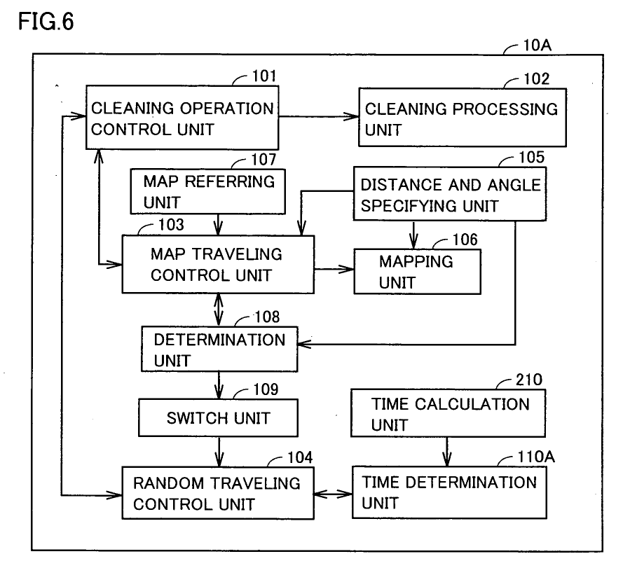

FIG. 5 is a flowchart showing a flow of the cleaning processes executed by CPU 10 in the embodiment of the present invention. Herein, this process is started, for example, when a user operates input unit 25 to input a command for starting cleaning. Alternatively, if information for designating a cleaning start time is inputted through input unit 25, this process is started on condition that a time measured by timer 21 becomes the designated time. The process shown in the flowchart of FIG. 5 is previously stored in memory 27 as a program. CPU 10 reads and executes this program, so that a function of the cleaning processes is realized.

With reference to FIG. 5, first, CPU 10 secures a predetermined storage region of memory 27, and initializes a map (step S101). Then, CPU 10 starts to perform map cleaning (step S102). More particularly, under the control of cleaning operation control unit 101, map traveling control unit 103 starts to perform map traveling and cleaning processing unit 102 starts to perform cleaning processes.

Next, map referring unit 107 refers to the map stored in memory 27 (step S103).

Then, CPU 10 determines whether or not the map cleaning is finished, on the basis of the referred map (step S104). If it is determined that the map cleaning is not finished (NO in step S104), the program proceeds to step S105.

In step S105, distance and angle specifying unit 105 specifies a traveling distance and an angle. More specifically, distance and angle specifying unit 105 specifies a traveling distance on the basis of detection signals from left rotary encoder 22 and right rotary encoder 23. In addition, distance and angle specifying unit 105 specifies an angle (in the main body traveling direction) on the basis of a detection signal from gyro sensor 28.

Next, determination unit 108 determines whether or not an angular velocity exceeds a predetermined value from the angle specified on the basis of the detection signal from gyro sensor 28 (step S105). If it is determined that the angular velocity does not exceed the predetermined value (NO in step S106), that is, if the angular velocity falls within a permissible range, the program proceeds to step S108. On the other hand, in step S106, if it is determined that the angular velocity exceeds the predetermined value (YES in step S106), that is, if the angular velocity deviates from the permissible range, the program proceeds to step S111.

In step S108, CPU 10 determines whether or not a traveling distance per predetermined time (speed) is less than a predetermined value, from the traveling distance specified on the basis of the detection signals from left rotary encoder 22 and right rotary encoder 23. If it is determined that the traveling distance per predetermined time is the predetermined value or more (NO in step S108), that is, if the traveling distance falls within a permissible range, the program proceeds step S110. On the other hand, in step S108, if it is determined that the traveling distance per predetermined time is less than the predetermined value (YES in step S108), that is, if the traveling distance deviates from the permissible range, the program proceeds to step S111.

In step S110, mapping unit 106 performs a mapping process on the basis of the traveling distance and the angle specified in step S105. After completion of the process in step S110, the program returns to step S103.

In step S111, switch unit 109 terminates the map cleaning (step S111). Subsequently, switch unit 109 starts to perform random cleaning (step S112). More specifically, under the control of cleaning operation control unit 101, random traveling control unit 104 starts to perform random traveling and cleaning processing unit 102 continuously performs the cleaning processes.

Then, time determination unit 110 determines whether or not a preset random cleaning time (also referred to as “setting time”) is elapsed (step S114). The random cleaning is performed until the setting time is elapsed (NO in step S114). This random cleaning time is set to be, for example, twice or three times as long as a general map cleaning average time. Herein, the time for random cleaning may be previously set by the user through input unit 25 or the like. Alternatively, the preset time may be changeable by the user.

In step S114, if it is determined that the setting time is elapsed (YES in step S114) or, in step S104, if it is determined that the map cleaning is finished (YES in step S104), a series of cleaning processes is finished.

As described above, even when cleaner 1 receives a strong impact so that an orbit of the main body is changed sharply (a position and a direction of the main body cannot be recognized), cleaner 1 switches the map cleaning to the random cleaning to continue the cleaning operation without halting the cleaning operation. Accordingly, it is possible to reduce an uncleaned region. In addition, the map cleaning is continuously performed as long as a strong impact is applied to cleaner 1 so that the position and the direction of the main body cannot be recognized. Thus, it is possible to perform efficient cleaning without remaining an uncleaned region.

In this embodiment, as described above, the cleaning operation is switched to the random cleaning if one of the angular velocity and the traveling distance deviates from the corresponding permissible range. However, the cleaning operation may be switched to the random cleaning only in the case where both the angular velocity and the traveling distance deviate from the permissible ranges. Herein, it may be determined whether or not only one of them falls within the corresponding permissible range. For example, only determination whether or not the angular velocity falls within the permissible range may be made without determination as for the traveling distance.

### Modification

Next, description will be given of a modification of the embodiment of the present invention. An outer appearance and a configuration of a cleaner according to the modification of the embodiment of the present invention are similar to those in the aforementioned embodiment. Therefore, description is made also herein using the reference characters shown in FIGS. 1 to 3.

In the aforementioned embodiment, when a preset time is elapsed after switching to the random cleaning, the cleaning operation is finished. On the other hand, in the modification of the embodiment of the present invention, a random cleaning time is calculated from a map at the time point that map cleaning is interrupted. This enables to perform more efficient cleaning.

It is to be noted that a CPU in the modification is denoted by a reference character 10A in order to distinguish from CPU 10 in the aforementioned embodiment.

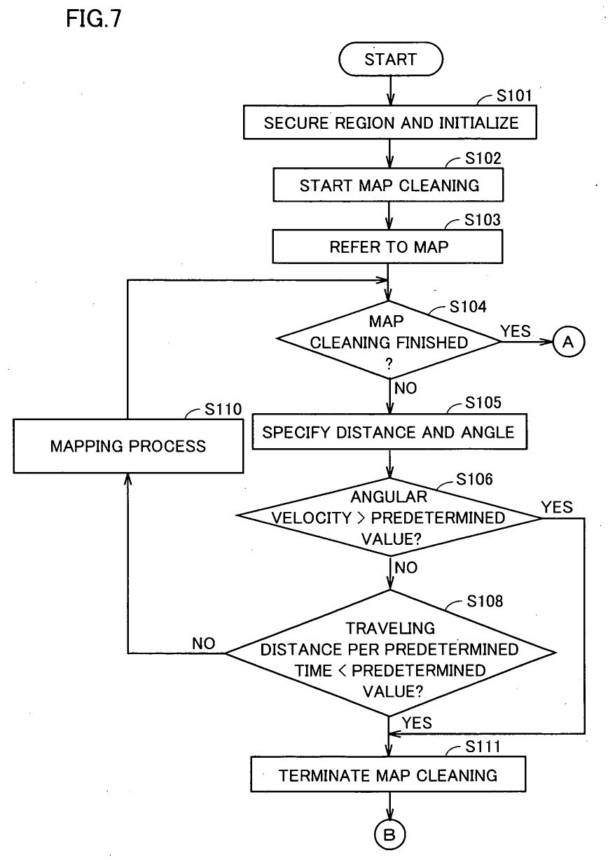

FIG. 6 shows functions realized by CPU 10A in the case where cleaner 1 according to the modification of the embodiment of the present invention performs a cleaning operation.

With reference to FIG. 6, CPU 10A further includes, in addition to the respective blocks shown in FIG. 4, a time calculation unit 210 for calculating a time for random cleaning. Moreover, a time determination unit 110A determines whether or not the time calculated by time calculation unit 210 is elapsed.

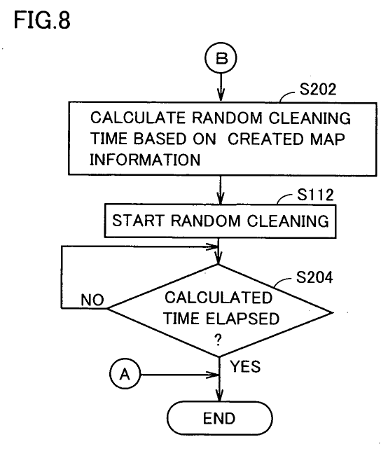

FIGS. 7 and 8 are flowcharts each showing a flow of cleaning processes executed by CPU 10A in the modification of the embodiment of the present invention. The processes shown in the flowcharts of FIGS. 7 and 8 are also previously stored in memory 27 as a program. CPU 10A reads and executes this program, so that a function of the cleaning processes is realized. Herein, like step numbers refer to like processes shown in FIG. 5 and description thereof will not be repeated.

With reference to FIG. 7, CPU 10A executes the aforementioned processes in steps S101 to S111. After completion of the process in step S111, the program proceeds to step S202.

With reference to FIG. 8, in step S202, CPU 10A calculates a random cleaning time based on the map stored in memory 27. For example, CPU 10A calculates, based on the map, a ratio of an uncleaned region in a cleaning space and refers to a table in which ratios are respectively corresponded to predetermined times, thereby calculating the random cleaning time. Alternatively, CPU 10A calculates, based on the map, an area of an uncleaned region and refers to a table in which areas of an uncleaned region are respectively corresponded to predetermined times, thereby calculating the random cleaning time.

After completion of the process in step S202, the program proceeds to step S112 where random cleaning is started.

Then, CPU 10A determines whether or not the time calculated in step S202 (hereinafter, referred to as “calculated time”) is elapsed (step S204). The random cleaning is performed until it is determined that the calculated time is elapsed (NO in step S204). Then, if it is determined that the calculated time is elapsed (YES in step S204), a series of cleaning processes is finished.

As described above, in the modification of the embodiment of the present invention, the random cleaning time is calculated on the basis of the information about the uncleaned region obtained from the map stored in memory 27. Accordingly, if the map cleaning is almost completed, in other words, if there is little uncleaned region, the random cleaning time becomes short. In contrast, if the map cleaning is switched to the random cleaning immediately after start of the map cleaning, there is large uncleaned region; therefore, the random cleaning time becomes long.

This enables to omit wasteful traveling and to perform efficient cleaning. In addition, the wasteful operations can be omitted, so that it is possible to achieve low power consumption.

The present invention can also provide, as a program, a cleaning method performed by the self-guided cleaning robot of the present invention. Such a program can be provided as a program product so as to be recorded in an optical medium such as a CD-ROM (Compact Disc-ROM) or a computer readable recording medium such as a memory card. Moreover, this program can be also provided by download through a network.

The program product to be provided is loaded on a program storage unit such as memory 27, for execution. Herein, the program product includes a program itself and a recording medium having the program recorded therein.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A self-guided cleaning robot comprising:
a suction unit for performing a sucking operation for cleaning;
a time measurement unit for measuring a time;
a storage unit for storing cleaning region information;
a travel unit for allowing a main body to move;
a traveling drive unit for driving said travel unit to allow said main body to travel;
a distance detection unit for detecting a traveling distance of said main body;
an angle detection unit for detecting an angle indicative of a moving direction of said main body;
a first traveling control unit for referring to said cleaning region information to control said traveling drive unit;
a mapping unit for mapping a cleaned partial region on the basis of information from said distance detection unit and said angle distance unit, while map traveling is performed by said first traveling control unit;
a second traveling control unit for controlling said traveling drive unit at random;
a first determination unit for determining whether or not a traveling distance per unit of a predetermined time is less than a first predetermined value, on the basis of a result of detection by said distance detection unit, while said map traveling is performed;
a second determination unit for determining whether or not an angular velocity exceeds a second predetermined value, on the basis of a result of detection by said angle detection unit, while said map traveling is performed; and
a switch unit for switching said map traveling to random traveling by said second traveling control unit, in the case where said first determination unit determines that said traveling distance per unit of the predetermined time is less than said first predetermined value and said second determination unit determines that said angular velocity exceeds said second predetermined value.

2. A self-guided cleaning robot comprising:
a suction unit for performing a sucking operation for cleaning;
a storage unit for storing cleaning region information;
a travel unit for allowing a main body to move;
a traveling drive unit for driving said travel unit to allow said main body to travel;
a detection unit for detecting a traveling state of said main body;
a first traveling control unit for referring to said cleaning region information to control said traveling drive unit;
a second traveling control unit for controlling said traveling drive unit at random;
a traveling state determination unit for determining whether or not the traveling state based on a result of detection by said detection unit falls within a preset permissible range, while map traveling is performed by said first traveling control unit; and
a switch unit for switching said map traveling to random traveling by said second traveling control unit, in the case where said traveling state determination unit determines that said traveling state deviates from said permissible range.

3. The self-guided cleaning robot according to claim 2, wherein said detection unit includes a distance detection unit for detecting a traveling distance of said main body,
said traveling state includes a traveling distance per unit of a predetermined time based on a result of detection by said distance detection unit,
said traveling state determination unit determines whether or not said traveling distance per unit of the predetermined time is less than a predetermined value, and
said switch unit switches said map traveling to said random traveling, in the case where said traveling state determination unit determines that said traveling distance per unit of the predetermined time is less than said predetermined value.

4. The self-guided cleaning robot according to claim 2, wherein said detection unit includes an angle detection unit for detecting an angle indicative of a moving direction of said main body,
said traveling state includes an angular velocity based on a result of detection by said angle detection unit,
said traveling state determination unit determines whether or not said angular velocity exceeds a predetermined value, and
said switch unit switches said map traveling to said random traveling, in the case where said traveling state determination unit determines that said angular velocity exceeds said predetermined value.

5. The self-guided cleaning robot according to claim 2, wherein said detection unit includes a distance detection unit for detecting a traveling distance of said main body, and an angle detection unit for detecting an angle indicative of a moving direction of said main body,
said traveling state includes a traveling distance per unit of a predetermined time based on a result of detection by said distance detection unit, and an angular velocity based on a result of detection by said angle detection unit, and
said traveling state determination unit includes a first determination unit for determining whether or not said traveling distance per unit of the predetermined time is less than a first predetermined value, and a second determination unit for determining whether or not said angular velocity exceeds a second predetermined value.

6. The self-guided cleaning robot according to claim 5, wherein said switch unit switches said map traveling to said random traveling in the case where said first determination unit determines that said traveling distance per unit of the predetermined time is less than said first predetermined value or said second determination unit determines that said angular velocity exceeds said second predetermined value.

7. The self-guided cleaning robot according to claim 5, wherein said switch unit switches said map traveling to said random traveling in the case where said first determination unit determines that said traveling distance per unit of the predetermined time is less than said first predetermined value and said second determination unit determines that said angular velocity exceeds said second predetermined value.

8. The self-guided cleaning robot according to claim 2, further comprising:
a mapping unit for mapping a cleaned partial region on the basis of a result of detection by said detection unit, while said map traveling is performed.

9. The self-guided cleaning robot according to claim 2, further comprising:
a time measurement unit for measuring a time; and
a time determination unit for determining whether or not an elapsed time since said switch unit switches said map traveling to said random traveling exceeds a preset time, wherein
said second traveling control unit terminates said random traveling, in the case where said time determination unit determines that said elapsed time exceeds said preset time.

10. The self-guided cleaning robot according to claim 2, further comprising:
a time measurement unit for measuring a time;
a calculation unit for referring to said cleaning region information stored in said storage unit to calculate a traveling time of said random traveling, in the case where said traveling state determination unit determines that said traveling state deviates from said permissible range; and
a time determination unit for determining whether or not an elapsed time since said switch unit switches said map traveling to said random traveling exceeds said calculated traveling time, wherein
said second traveling control unit terminates said random traveling, in the case where said time determination unit determines that said elapsed time exceeds said calculated traveling time.

11. The self-guided cleaning robot according to claim 10, further comprising:
a correspondence table in which ratios of an uncleaned region are respectively corresponded to predetermined times, wherein
said calculation unit calculates a ratio of said uncleaned region on the basis of said cleaning region information, and calculates said traveling time on the basis of said calculated ratio and said correspondence table.

12. The self-guided cleaning robot according to claim 10, further comprising:
a correspondence table in which areas of an uncleaned region are respectively corresponded to predetermined times, wherein
said calculation unit calculates an area of said uncleaned region on the basis of said cleaning region information, and calculates said traveling time on the basis of said calculated area and said correspondence table.
